(19) United States
(12) Patent Application Publication
(10) Pub. No.: US 2012/0175048 A1
(43) Pub. Date: Jul. 12, 2012

(54) METHOD AND APPARATUS FOR MANUFACTURING A SEMIFINISHED PRODUCT FOR TUBULAR LABELS

(76) Inventors: Mauro Vincenzo Bonelli, Milano (IT); Enrico Danovaro, Milano (IT)

(21) Appl. No.: 13/389,039

(22) PCT Filed: Aug. 5, 2010
(86) PCT No.: PCT/IB2010/053551

§ 371 Date: Mar. 26, 2012

(30) Foreign Application Priority Data
Aug. 7, 2009 (IT) MI2009A001436

(51) Int. Cl. B65C 3/00

(52) U.S. Cl. 156/200; 156/459

(57) ABSTRACT

A method for making a semifinished product for tubular labels comprises the steps of unwinding a ribbon (3) from a bobbin (4), feeding the ribbon (3) through a compensation magazine (5), inside of which the ribbon (3) temporarily stands, and bending said ribbon (3) into a tubular shape between the step of unwinding the bobbin (4) and the step in which the ribbon (3) stands in the compensation magazine (5). A modular unit (1) for making a semifinished product for tubular labels comprises an unwinding station (2) for unwinding a ribbon (3), a compensation magazine (5) into which the ribbon (3) is unwound waiting for further processing, and a tube-making module (11) arranged between the unwinding station (2) and the compensation magazine (5).

The present invention relates to a method for making a semifinished product for tubular labels and to a modular unit for making a semifinished product for tubular labels.

In particular, said modular unit is useful for labelling bottles or, more in general, any substantially cylindrical containers, even having irregular (e.g. square, rectangular, oval, polygonal and/or truncated-cone) shapes.

Machines for making tubular labels are known which comprise a unit for unwinding a ribbon preferably made of “heat-shrinkable” material, in which unit the ribbon is converted into a tube and is sealed with an overlapping of a few millimetres by using a chemical sealing material, after which the tube is wound around cardboard rings and is ready for use in application machines; this step is carried out by a device of the type called “converter”.

These converter-type machines are operated by the manufacturer of semifinished films (called sleeves), that supplies to the client a heat-shrinkable tube shaped label wound around a cardboard ring. This tube label is then applied by suitable machines, which lay it onto the container (bottle, jar or the like) at the desired height, and is then adapted to the container's shape by going through a heat source.

The present invention relates to a module which allows a flat film to be converted into a tube in order to directly supply the machine that applies the tubular semifinished label (i.e. the sleeve) onto the product, so that the conversion step is carried out directly by the user, i.e. where the labels are applied to the products.

Anyway, this module may also be used for preparing bobbins of cardboard-wound tubular material.

The film being flat, this module allows to use very large bobbins (up to 5,000 metres) lasting much longer than tubular label rolls, which typically do not exceed 1,000 metres, thus requiring less frequent bobbin changes and providing considerable savings on packaging and transportation costs.

In this frame, the technical object of the present invention is to propose a method for making a semifinished product for tubular labels and a modular unit for making a semifinished product for tubular labels which overcome the above-mentioned drawbacks of the prior art.

In particular, it is an object of the present invention to provide a modular unit for making a semifinished product for tubular labels which is structurally simpler than the prior art, as well as a manufacturing method thereof which allows to cut down, even only partially, labelling times.

It is a further object of the present invention to propose a modular unit for making a semifinished product for tubular labels which is both small and flexible, i.e. which can be managed easily especially when changing the label format, and which can be adjusted, even only minimally, when in operation.

It is another object of the present invention to provide a modular unit for making a semifinished product for tubular labels which can process a wide range of materials and which ensures flexibility in the choice of the most suitable material while also involving low supply costs.

Finally, it is yet another object of the present invention to propose a modular unit for making a semifinished product for tubular labels which can be coupled to machines already in use.

The above technical objects are substantially achieved through a method for making a semifinished product for tubular labels and through a modular unit for making a semifinished product for tubular labels comprising the technical features set out in one or more of the appended claims.

Further features and advantages of the present invention will become more apparent from the following non-limiting, explanatory description of a preferred but non-exclusive embodiment of a modular unit for making a semifinished plastic-film product for tubular labels as shown in the annexed drawings, wherein:

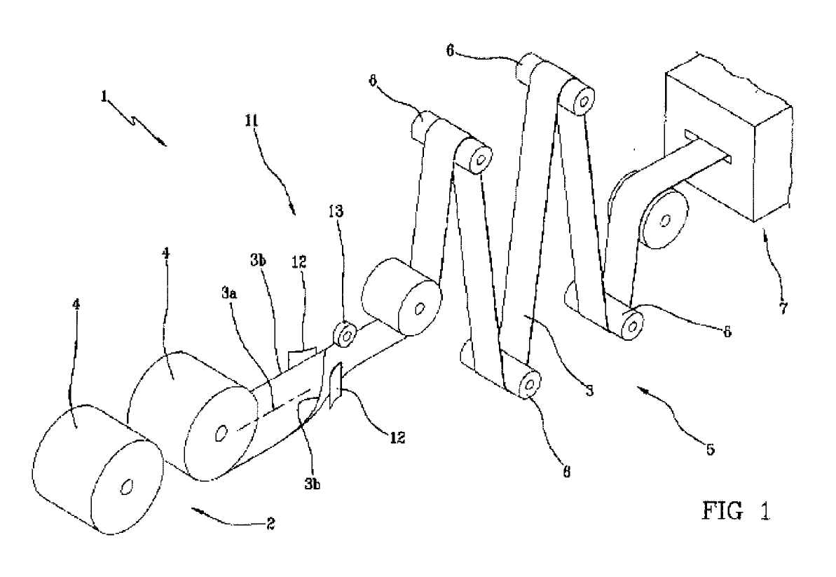

FIG. 1 is a schematic view of a modular unit for making a semifinished product for tubular labels according to the present invention;

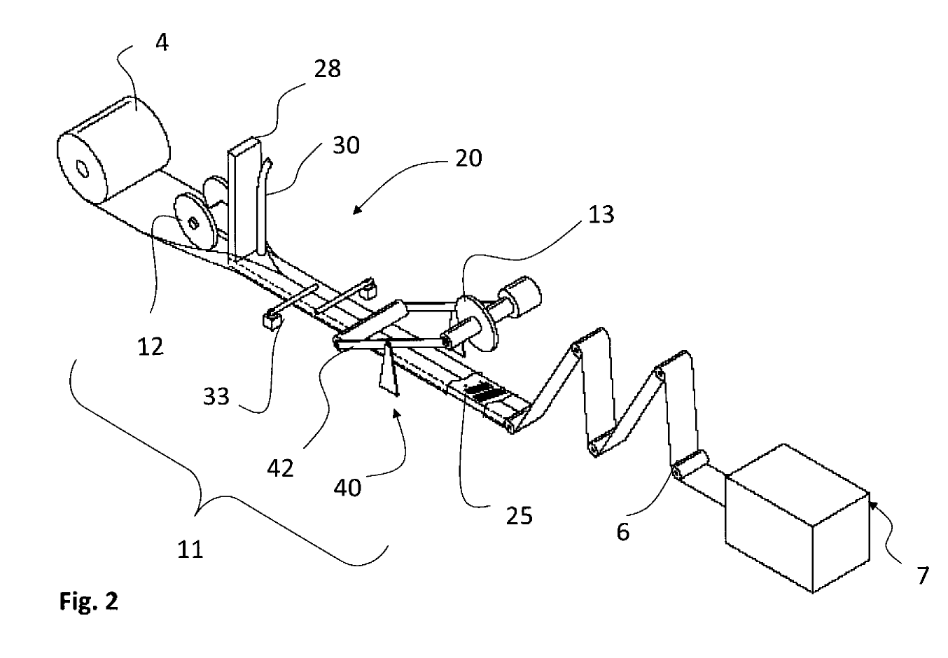

FIG. 2 is a schematic view of a variant of the modular unit of FIG. 1 including a vacuum station;

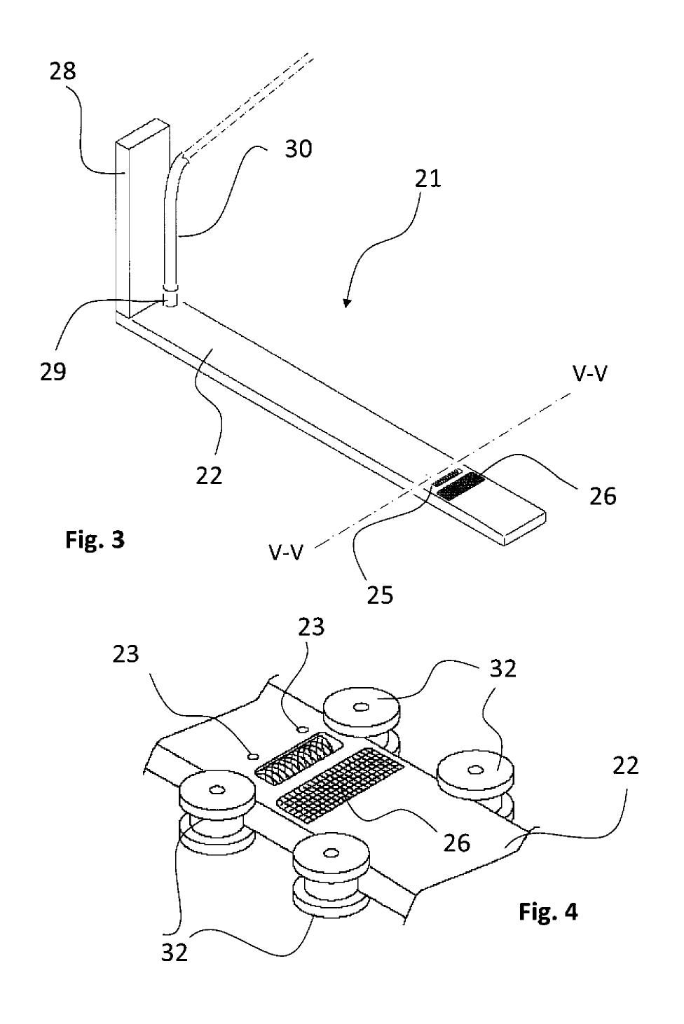

FIGS. 3 and 4 show some details of the variant of the modular unit of FIG. 2;

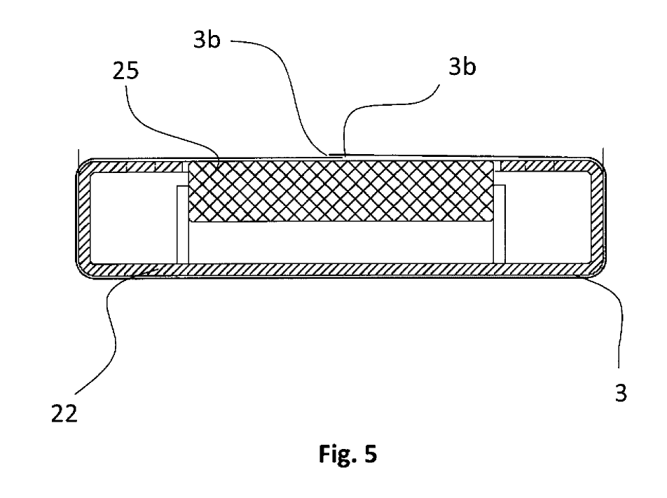

FIG. 5 is a sectional view along the line V-V of FIG. 3.

Referring now to the annexed FIG. 1, reference numeral 1 designates as a whole a modular unit for making tubular labels.

The modular unit comprises an unwinding station 2 for unwinding a ribbon 3, and a compensation magazine 5 arranged downstream of the unwinding station 2, into which magazine the ribbon 3 is unwound waiting for further processing.

The unwinding station 2 comprises at least one bobbin 4 of ribbon 3, but advantageously the bobbins 4 may be two or more, so as to ensure that the ribbon 3 is fed continuously to the compensation magazine 5.

In particular, said magazine 5 includes intermediate rollers 6 for the ribbon 3, which create bends that provide a reserve of material that can be used during the bobbin change step, in particular when the final portion of the ribbon being processed must be connected to the initial portion of the ribbon of the new bobbins, or in the event that the speed of other units downstream of the modular unit 1 is temporarily changed.

The ribbon 3 is preferably made of heat-shrinkable or extensible polymeric material; more preferably, it is wound as a single layer into a bobbin 4.

Some polymeric materials which may be used for said ribbon are, for example, PET, PVC, PP, OPS, PLA, PE and the like.

Advantageously, the material used may be heat-shrinkable and/or extensible transversally, thus offering a remarkable advantage when processing the ribbon 3.

Between the unwinding station 2 and the compensation magazine 5 there is a tube-making module 11 for making the ribbon 3 into a tubular body.

In other words, in this module 11 the ribbon, unwound from the bobbin 4, is bent into a tubular shape by suitable bending elements 12 and is at the same time closed into a tube by a sealing element 13, which longitudinally seals two lateral end edges 3b of the ribbon 3 to each other, which edges are parallel to the longitudinal axis 3a of the ribbon 3.

Within the tube-making module 11, it is possible to adjust the transversal dimension of the tube-shaped ribbon, thus making the modular unit extremely flexible in case of label format changes or small label size adjustments.

The tube-shaped ribbon 3 then exits this module 11 and goes through the compensation magazine 5.

The modular unit 1 described so far can be coupled to a machine adapted to apply tubular labels, generally indicated in FIG. 1 by reference numeral 7.

In particular, such a machine 7 can be arranged downstream of the compensation magazine 5 and may comprise a station where the tubular ribbon 3 is cut, while being possibly subjected to suitable thermal treatments, in order to transform the label into individual labels having the desired height, which are then fitted around a container.

When in use, inside the unwinding station 2 the bobbin 4 of ribbon 3 of single-layer material is unwound and fed into a tube-making module 11.

In said module 11, the single-layer ribbon is bent into a tubular shape and sealed along the junction lines of the two lateral edges 3b of the ribbon 3 itself.

The tube-making step is carried out continuously, and allows to obtain a continuous ribbon of tubular labels.

At the exit of the tube-making module 11, the ribbon 3 follows a winding path within the compensation magazine 5, supported by the intermediate rollers 6.

The ribbon 3 temporarily stands within the magazine 5 waiting to be used, downstream of the magazine 5, by a machine 7 to which the modular unit 1 can be coupled.

The objects of the invention are thus fully attained.

The modular unit 1 described herein can be adapted to existing machines, making the latter particularly flexible as far as format changes are concerned, while providing savings on the cost of the label, since this is produced directly at the site of use.

As previously explained, the modular unit can be handled easily at format change, and also allows for small label size adjustments.

The step of making and sealing the tubular label are carried out continuously on the entire ribbon, thereby avoiding the need of alternating the cutting step with the bending and sealing step.

Therefore the modular unit according to the present invention allows to reduce the time necessary for making the individual labels.

Besides, since the bobbin is formed by a single-layer ribbon, there is more usable ribbon in a bobbin of the same diameter. The diameter being equal, the bobbin is at least twice as long.

The modular unit described herein accepts any type of material, and allows to choose the best materials at reduced costs.

Of course, the invention described so far may be subject to many variations, one of which is shown in FIGS. 2 to 5, wherein the reference numerals designate parts being structurally or functionally equivalent to those already described with reference to the previous example.

In particular, in this variant the tube-making module 11 comprises a vacuum station 20 downstream of the bending elements 12; for this purpose, the station 20 comprises a bending jig 21 consisting of a boxed section 22 extending horizontally in the feeding direction of the ribbon 3, on the upper wall of which there are holes 23 which put the inside of the section in communication with the outside.

According to this embodiment, downstream of the holes 23 there are a knurled roller 25 and a slide band 26, the functions of which will be described below; around the bending jig 21 there are rollers 32 for trimming the edge of the tubular label, which is then sealed downstream of the vacuum station 20 by a roller 13, to which reference will be made more in detail hereafter.

The jig 21 is suspended from above by means of a column 28, which also supports, on the side opposite to the jig, the bending elements 12, in this case consisting of one pair of horizontal-axis idle rollers; near the column 28, the section 21 is provided with a fitting 29 for connecting it, through a hose 30, to a suction source such as a compressor, an autoclave or the like, not shown in the drawings.

According to a preferred embodiment, the bent portions of the film 3 are held in the bent condition around the section 22 with the edges 3b accurately overlapped, ready for being sealed, by a set of lateral guide rollers 32 and pressure elements 33, provided in the form of bars extending transversally to the ribbon 3 along the vacuum station 20.

Downstream of the latter, a sealing station 40 is provided along the section 22 which comprises, as aforementioned, a roller 13; according to this variant of the invention, the sealing of the edges 3b of the plastic film is accomplished by means of ultrasound.

This avoids any problems due to the plastic material melting and depositing on the hollow section 22, which may cause damage to the film or anyway hinder the feeding thereof.

Therefore, the sealing roller 13 is in this case a sonotrode supported by a horizontally-pivoted structure 42, which also carries the motor that drives the roller 13: the horizontally-pivoted structure 42 allows the roller to be raised and lowered in order to be moved from an idle condition, wherein it is away from the tubular ribbon 3, to an operating condition, wherein it is in contact with the ribbon to continuously seal the edges 3b thereof.

This variant of the invention operates as follows.

The flat ribbon 3 of heat-shrinkable plastic film unwound from one of the two bobbins (referred to as 4 in FIG. 1) is bent by the bending means 12, so that its edges are bent around the hollow section 22 of the bending jig 21; this step is made easier by the vacuum (approx. 10 kPa) created within the section 22 by sucking air through the fitting 29 and the hose 30.

In fact, the air present between the plastic film of the ribbon 3 and the bending jig 21 is sucked in through the holes 23 and evacuated through the hose 30, so that the bent ribbon portions adhere to the jig and the edges 3b accurately overlap, thus getting ready for the subsequent sealing step.

The latter takes place with the sonotrode roller 13 held down by the horizontally-pivoted structure 40; the roller 13 can carry out an accurate sealing thanks to the section 22 on which the tubular ribbon 3 slides, which ensures the necessary counter reaction to keep the plastic film of the ribbon 3 and the sealing surface of the roller 13 optimally in contact with each other.

In normal conditions, the vacuum station 20 and the sealing station 40 operate continuously, so that the ribbon edges are sealed without interruption by the sonotrode roller 13. This leads to the production of a tubular ribbon ready for being sent to the compensation magazine 5 along a winding path defined by the intermediate rollers 6, and then to the next machine for applying the tubular labels, referred to as 7 in FIG. 1.

As can be easily understood, also this variant achieves the above-described technical objects at the basis of the invention.

In fact, it allows to make a continuous semifinished product for tubular labels in a simple and accurate manner, independently of the type of labelling machine located downstream. Thanks to the tube-making module 11 including the vacuum station 20 and the sealing station 40 designed as explained above, it is possible to carry out a high-quality sealing of the plastic film even when the operating conditions change.

The vacuum causes the bent portions of the ribbon film to adhere to the bending jig, so that the ribbon edges 3b remain stable in the predetermined sealing position; in addition, since the section 22 is used for the air suction and vacuum creation function as well as for countering the sealing roller 13, both operations can be carried out within a limited space. It follows that there is no substantial increase in the dimensions of the modular unit according to this variant of the invention compared to the preceding one.

It should also be pointed out that the performance of the modular unit remains constant as the operating conditions change.

For example, in the event that the feeding speed of the ribbon 3 must be changed due to a problem arisen in the labelling machine located downstream of the modular unit 1 according to the invention, it is possible to adapt said ribbon speed and the speed of the sealing operation carried out by the roller 13 without any rebounds, since the downstream compensation magazine 5 will absorb any speed differences.

1. A method for making a semifinished product for tubular labels, comprising the steps of unwinding a ribbon from a bobbin and feeding the ribbon through a compensation magazine inside of which the ribbon temporarily stands, wherein said method further comprises the step of making said ribbon into a tubular body between the step of unwinding the bobbin and the step in which the ribbon stands in the compensation magazine.

2. A method according to claim 1, wherein the step of making the ribbon into a tubular body comprises the step of bending said ribbon into a tubular shape.

3. A method according to claim 2, wherein the step of making the ribbon into a tubular body comprises the further step of sealing said ribbon bent into a tubular shape along a longitudinal line defined by two respective lateral end edges of the ribbon.

4. A method according to claim 3, wherein the steps of bending and sealing said ribbon are carried out in succession within a tube-making module arranged between an unwinding station, where the ribbon is unwound from the bobbin, and a compensation magazine, where the ribbon temporarily stands.

5. A method according to claim 1, further comprising the step of cutting said tubular ribbon into individual labels.

6. A modular unit for making a semifinished product for tubular labels comprising an unwinding station to unwind a ribbon from a bobbin, and a compensation magazine within which the unwound ribbon temporarily stands, wherein said unit further comprises a module for making said ribbon into a tubular body, arranged between said unwinding station and said compensation magazine.

7. A modular unit according to claim 6, wherein said ribbon is a film of preferably heat-shrinkable material, more preferably consisting of a single layer.

8. A modular unit according to claim 6, wherein said tube-making module is adapted to bend said single-layer ribbon into a tubular shape and to close it into a tube by longitudinally sealing two lateral end edges to each other, which edges are parallel to the longitudinal axis of the ribbon itself.

9. A modular unit according to claim 6, wherein said unwinding station comprises at least one bobbin of said ribbon.

10. A modular unit according to claim 9, wherein said unwinding station comprises at least two bobbins of said single-layer ribbon arranged in succession in such a manner as to ensure that the ribbon is fed continuously to the tube-making module.

11. A modular unit according to claim 6, wherein said tube-making module comprises bending elements adapted to bend the ribbon into a tubular shape, and a sealing element adapted to close the ribbon into a tube by longitudinally sealing two lateral end edges of the ribbon to each other, which edges are parallel to the longitudinal axis of the ribbon.

12. A modular unit according to claim 10, wherein the tube-making module comprises a vacuum station between the bending elements and the sealing element, in which station the air within the ribbon bent into a tubular shape is evacuated.

13. A unit according to claim 12, wherein the vacuum station comprises a bending jig with a boxed section around which the ribbon is bent, and wherein at least one internal portion of the section is in fluidic communication with air suction means.

14. A unit according to claim 13, wherein the section has holes in the area where the ribbon is bent, and is connected internally to an air suction source.

15. A modular unit according to claim 6, wherein said unit further can be coupled to a label-making machine adapted to cut said ribbon into labels or to wind it into a bobbin.

16. A method according to claim 2 further comprising the step of cutting said tubular ribbon into individual labels.

17. A method according to claim 3 further comprising the step of cutting said tubular ribbon into individual labels.

18. A method according to claim 4 further comprising the step of cutting said tubular ribbon into individual labels.

19. A modular unit according to claim 7, wherein said tube-making module is adapted to bend said single-layer ribbon into a tubular shape and to close it into a tube by longitudinally sealing two lateral end edges of the ribbon to each other, which edges are parallel to the longitudinal axis of the ribbon itself.

20. A method for making a semifinished product for tubular labels, comprising the steps of: unwinding a ribbon from a bobbin; making said ribbon into a tubular body by bending said ribbon into a tubular shape, and then sealing said ribbon along a longitudinal line defined by two respective lateral end edges of the ribbon; feeding said ribbon through a compensation magazine inside of which said ribbon temporarily stands; and cutting said ribbon into individual labels, wherein the steps of bending and sealing said ribbon are carried out in succession within a tube-making module arranged between an unwinding station where said ribbon is unwound from the bobbin, and a compensation magazine where said ribbon temporarily stands.
